(19) United States
(12) Patent Application Publication
(10) Pub. No.: US 2010/0145810 A1
(43) Pub. Date: Jun. 10, 2010

(54) AUTOMATED SUBSTANTIATION OF PRODUCT LEVEL SPECIFIC ACCOUNT PAYMENTS

(76) Inventors: Stacy Pourfallah, Oakland, CA (US); Janet Pruitt, Madison, AL (US)

Correspondence Address: Quarles & Brady LLP, TWO NORTH CENTRAL AVENUE, One Renaissance Square, PHOENIX, AZ, 85004-2391, US

(21) Appl. No.: 12/630,748

(22) Filed: Dec. 3, 2009

Related U.S. Application Data
(60) Provisional application No. 61/120,408, filed on Dec. 6, 2008.

(51) Int. Cl. G06Q 20/00; G06Q 10/00; G06Q 30/00

(52) U.S. Cl. 705/17; 705/30; 705/44

(57) ABSTRACT

Transactions are processed in which payment is made using an account, such as a health savings account or other type of account in which cardholder purchases are limited to, and/or are documented for, a pre-designated set of merchandise. When a transaction occurs, the purchased products are identified and a determination made whether each product is qualified for purchase under the account. An account transaction record is stored which identifies the date of the transaction, the account, each item that is qualified under the account, a description and quantity of each item, and the total monetary amount of the transaction related to such qualified items. The account transaction records for a particular consumer are used to generate a report that contains data for every transaction on the account. The report can be limited to those transactions that occurred during a period of time, such as a calendar year.

### CROSS-REFERENCE TO RELATED APPLICATIONS

This Application claims priority to, and the benefit of, U.S. Provisional Application Ser. No. 61/120,408, titled “Automated Substantiation Of Health Savings Account Payments,” filed on Dec. 6, 2008, which is incorporated herein by reference.

### FIELD

The present invention relates to accounts, such as Health Savings Accounts (HSAs), or other types of accounts that may rely on product level data, such as stock keeping unit (SKU) level information, for determining transaction amounts in which a portable payment device, such as a debit card, can be used to pay for purchases; and in particular to record keeping required of users of such accounts.

### BACKGROUND

Payment transaction processing systems have been created to enable consumers to pay for products and services at merchants without exchanging money at the time of the purchase. An exemplary transaction processing system 100, depicted in FIG. 1, includes an issuer or issuer payment card processor company 104 of a payment account for use by a consumer 102; a transaction handler 106, such as a credit card company; an acquirer or merchant payment card processor company 108; and a merchant 110. Payment accounts are issued to individual people and to business entities, thus the consumer 102 may be a person to whom the payment account was issued or may be a person having access to the account, such as an employee of a business entity to which the payment account was issued. When a payment account is opened, the issuer 104 often provides a portable payment device 112 for use by the consumer 102. Examples of portable payment devices include a credit or debit card, a smartcard (i.e.; a card with an integrated circuit chip for storage of information and applications), a smart media, a payroll card, a healthcare card, a wrist band, a machine readable medium containing account information, a keychain device such as the SPEEDPASS® commercially available from ExxonMobil Corporation or a supermarket discount card, a credit or debit or other card with an integrated wireless chip such as the Visa payWave® card commercially available from Visa Inc., or MasterCard PayPass® card commercially available from MasterCard International, a cellular phone, personal digital assistant, a pager, a security card, a computer, an access card, a wireless terminal, or a transponder. A portable payment device 112 may have a volatile or non-volatile memory to store information such as the account number or an account holder's name, which can be read by equipment at the merchants.

A typical transaction begins with the consumer 102 presenting an account number, such as through the use of a computer terminal or a portable payment device 112, to the merchant 110 to pay for the purchase of a product or service. The merchant 110 may utilize a Point of Service (POS) terminal 113 to read a payment account number from the portable payment device 112. The portable payment device 112 may interface with the POS terminal using a mechanism including any suitable electrical, magnetic, or optical interfacing system, including Bluetooth, infrared and wireless capabilities. The POS terminal 113 is in operative communication with the transaction processing system 100 and can communicate with the acquirer 108, the transaction handler 106, or the issuer 104. For a usual purchase transaction, the POS terminal sends a transaction authorization request 116 to the issuer 104 of the portable payment device 112. Alternatively, or in combination, the portable payment device 112 may communicate with the issuer 104, the transaction handler 106, or the acquirer 108.

The issuer 104 responds by approving or denying the transaction authorization request using the transaction handler 106. Approval includes the issuer 104, or the transaction handler 106 on behalf of the issuer 104, authorizing the purchase transaction in compliance with the issuer's 104 instructions, such as through the use of business rules. A message 118 indicating approval or denial of the transaction authorization request is sent back through the transaction handler 106 to the merchant 110. The transaction handler 106 may maintain a log or history of authorized transactions. Once approved, the merchant 110 records the authorization and delivers the product or service to the consumer 102.

The merchant 110 may, at discrete periods, such as the end of the day, submit a list of authorized transactions to the acquirer 108 or other components of the transaction processing system 100. The transaction handler 106 may compare the submitted authorized transaction list with its own log of authorized transactions. If a match is found, the transaction handler 106 may route authorization transaction amount requests from the corresponding acquirer 108 to the corresponding issuer 104 involved in each transaction. The acquirer 108 is responsible for ensuring payment to the merchant 110 of the authorized transaction amount from the issuer 104, less any transaction costs, such as fees, based on the terms negotiated between the acquirer 108 and the merchant 110.

There may be intermediate or subsequent steps in the foregoing process, some of which occur simultaneously. For example, the acquirer 108 can initiate the clearing and settling process, which can result in payment to the acquirer 108 for the amount of the transaction. The acquirer 108 may request from the transaction handler 106 that the transaction be cleared and settled. Clearing includes the exchange of financial information between the issuer 104 and the acquirer 108, and settlement includes the exchange of funds. The transaction handler 106 most typically provides services in connection with settlement of the transaction. The transaction handler 106 instructs the settlement bank to debit the issuer's 104 account in the settlement bank for the funds due, and instructs the acquirer's 108 account in the settlement bank to be credited for the funds due. Typically, the settlement bank is chosen by the transaction handler 106, and an issuer 106 and an acquirer 108 establish instructions with the settlement bank regarding their account. Thus, a typical transaction involves various entities to request, authorize, and fulfill the processing of the transaction for clearing and settlement.

The exemplary transaction processing system 100 also is employed to process purchase transactions that involve a flexible spending account, health savings account, or other types of accounts that rely on stock keeping unit (SKU) level data. An example of a use of a flexible spending account is disclosed in US Patent Application Publication No. 20060149670, titled “Auto substantiation for over-the-counter transactions,” filed on Sep. 20, 2005, which is incorporated herein by reference in its entirety. In the United States, insurance companies provide policies with different deductible levels designating an amount of money that the policyholder has to pay toward specified health related expenses before the insurance company begins paying for those expenses. Policyholders with higher deductible level policies are eligible to establish a health savings account under the regulations of the U.S. Internal Review Service (IRS). This allows the policyholder to deposit up to a designated amount pretax income into a qualified health savings account administered by an issuer institution and use that amount to pay for health related expenses. To preserve the tax-advantaged status of health savings account funds, the health savings account may be used to pay for only those health related products and services that are defined by the IRS regulations as deductible medical expenses. Use of the money in a health savings account for other types of expenses subjects the policyholder to income taxes and penalties levied by the IRS. Another example is the Medicare Advantage Plan program which allows Medicare recipients, such as senior citizens, to enroll in a plan that provides additional benefits as long as the Medicare Advantage Plan card is used at specific providers or to purchase qualifying items. Two additional examples of other account types include a business account which permits employees to only purchase office or business-related merchandise and services on behalf of the business, and second, a general limited-purpose account, such as a account that permits only designated merchandise to be purchased in the case of a promotional or incentive program limited to the designated merchandise.

The IRS may audit a health savings account requiring the associated policyholder to provide receipts for each payment made from that account to verify the nature of each product or service for which payment was made. A Medicare Advantage type program may have similar requirements. This requires the policyholder to perform meticulous recordkeeping and to retain those receipts for several years. Many people find it difficult to perform the necessary recordkeeping and thus do not participate in a health savings account or use a Medicare Advantage plan, even though they would benefit from doing so.

Therefore, it is desirable to provide a recordkeeping program to track transactions that involve accounts like a health savings account or Medicare Advantage plan and provide the necessary documentation to substantiate proper use of that account.

### SUMMARY

A transaction processing system enables a transaction handler to process sales transactions involving the purchase of products or services wherein, each sales transaction is characterized by a consumer and a merchant engaging in a sales transaction upon an account that was provided to the consumer by an issuer. In one implementation a payment authorization request is sent. The payment authorization request requests use of an account to conduct for a sales transaction for a purchase of one or more items by the consumer from the merchant. A determination is made as to whether each item requested for the purchase by the consumer in the sales transaction is qualified under the account. An account transaction record is stored and contains information of the determination of each item that is qualified under the account for the sales transaction. Each such sales transactions can be processed by a transaction handler in a transaction processing system, where the sales transaction is characterized by a consumer making a purchase of one or more items from a merchant, and where payment is made upon the account that was issued to the consumer by an issuer. Stated otherwise, the account transaction record can contains information required by regulations related to the account in order to justify use of the account to purchase the qualified items. The account transaction record can identify the date of the transaction, the account, each item that is qualified under the account, a quantity and a unit cost of each qualified item, data enabling a determination of the total monetary amount of the transaction related to such qualified items, and a total monetary amount of the transaction.

In different implementations, account record keeping is performed using account transaction records which can be retained by the merchant, the acquirer, the transaction handler, or the issuer. Account transaction records may contain some or all identifying information for the consumer, the merchant's acquirer, and the merchant, as well as transaction information, and product level detail regarding the items purchased.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block diagram illustrating an exemplary previously used transaction processing system;

FIG. 2 is a block diagram illustrating a first transaction processing system that incorporates the present invention;

FIG. 3 is a block diagram illustrating a second transaction processing system that incorporates the present invention;

FIG. 4 is a block diagram illustrating a third transaction processing system that incorporates the present invention; and

FIG. 5 is a block diagram illustrating a fourth transaction processing system that incorporates the present invention.

FIG. 6 illustrates an exemplary payment processing network.

FIG. 7 illustrates systems housed within an interchange center to provide online and offline transaction processing; and

FIG. 8 illustrates another view of the components of FIG. 6.

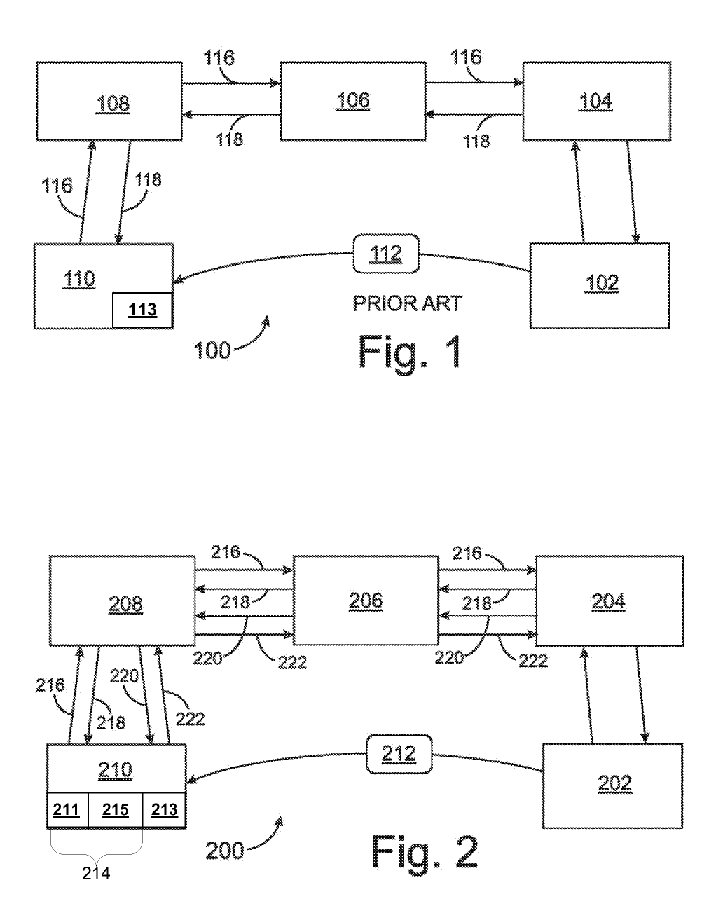

### DESCRIPTION

The present implementations facilitate mandated recordkeeping of transactions that are conducted on a particular type of account, where business rules, government regulations, or other limitations have been placed upon the account as to the record keeping for certain types and kinds of goods and services that are purchased in transactions that are conducted on the account. A transaction that is conducted on this type of account requires an examination of specific information about each product that is to be purchased in the transaction. Once this product level information about each product is acquired, the information is assessed against criteria in order to substantiate whether particular record keeping is be used for the transaction for the purchase of each such product. As such, this type of the account can be characterized as a product level specific account, and payments on the account for transactions that are proper conducted on the account can be characterized as product level specific account payments. Several scenarios can result from an attempt to use of such an account to conduct a transaction for the purchase goods or service that, upon assessment, fail to meet the criteria. Once such scenario is that the transaction will be refused. Another scenario is that the transaction is authorized, but record keeping is performed as to those goods and services in the transaction that did, and/or did not, meet the criteria. Any such transaction can be characterized as a product level specific account transaction or a “Targeted Acceptance Transaction” (TAT). Any type of account upon which TATs can be conducted can be characterized as a product level specific account or a “Targeted Acceptance Account” (TAA). By way of example, and not by way of limitation, examples of a TAA include: (i) a Health Savings Account (HSA); (ii) a Employee Benefits Account (EBA); (iii) an account that can only be used to conduct transactions for the purchase food or foods within one or more particular categories of food; (iv) a Flexible Savings Account (FSA); (v) an account that can only be used to conduct transactions for the purchase of automotive goods and services (e.g.; a fleet account); (vi) an account that can only be used to conduct transactions for the purchase of public transit services; (vii) an account that can only be used to conduct transactions for the purchase of travel and entertainment related goods and services (e.g.; a T&E account); (viii) an account that can only be used to conduct transactions for the purchase of goods and/or services that have been preauthorized by a third party, such as a parent, guardian, employer, governmental authority, etc., where the third party has a corresponding relationship with a consumer who is conducting the TAT on the TAA with a merchant.

Although examples are given below, and in reference to the Figures, for transactions conducted by a consumer on an HSA for the purchase of goods and services from a merchant who is a healthcare provider of healthcare related goods and/or services provider, those of ordinary skill in the relevant arts will understand that the examples also apply to other such TAAs used to conduct other such TATs.

An HSA can be used to conduct a TAT by use of a portable payment device, where the TAT can be handled by a transaction processing system. The HSA generally characterizes a debit account in which money is deposited for subsequent payment of medical and health related expenses, and includes, but is not limited to, accounts established pursuant to the Internal Revenue Code of the United States of America, and other legislation that may be enacted pertaining to healthcare expense reimbursement. As such, an HSA is a TAA that can only be used to conduct TATs.

With reference to FIG. 2, a first transaction processing system 200 enables a consumer 202 to pay for products and services acquired from a merchant 210 utilizing a portable payment device 212, such as a debit card, that was issued to the consumer by an issuer 204. With respect to processing transactions for a health savings account, the merchant 210 may be any entity that provides products or services which may be paid for with funds from such an account. For example, the merchant may include, but is not limited to, a supermarket, a discount store, a pharmacy; a provider of medical appliances; a company that provides medical equipment, such as oxygen generators, hospital beds, and the like; medical practitioners, such as physicians and dentists; and medical facilities, such as hospitals, outpatient clinics, and nursing homes. The products and services for which payment may be eligible for tax-advantaged status utilizing a health savings account are those which are defined by the laws and regulations related to such accounts.

The typical transaction involves the consumer 202 presenting the portable payment device 212 to the merchant 210 at the time that the products or services are obtained or ordered. The merchant 210 may swipe or scan the portable payment device 212 into a point of sale terminal 213 or otherwise enter the associated account number into that point of sale terminal. For merchandise being purchased, the universal product code (UPC) written as a bar code on each item is scanned by the point of sale terminal. Utilizing the universal product code, or alternatively a merchant's stock keeping unit (SKU) number, the point of sale terminal 213 interrogates a conventional database 215 stored within memory 214 which contains information about all the products and services available for purchase at the merchant 210; this database, for instance, can be used to print item descriptions and prices on sales receipts. The database is indexed by the universal product code or the stock keeping unit number and may indicate whether or not that particular product or service qualifies for payment under a health savings account. Other information about that particular product or service, such as its name (e.g. Bayer® aspirin) and the cost of the item, also are obtained from that database. The merchant then determines the total monetary amount of the qualified items, i.e., the items which are eligible for payment from an account such as a health savings account. Thus the merchant prescreens the items in the transaction for those which may be eligible for tax-advantaged status with the health savings account. The total monetary amount of the qualified items plus taxes and any additional discounts, such as from a coupon presented by the consumer, that the consumer may present, are calculated separately, along with the total amount of the purchase.

The merchant 210 then formulates a payment authorization request 216. The payment authorization request 216 contains an identification of the merchant 210, the amount of the purchase for which authorization is being requested, and the account number that was entered into the point of sale terminal 213. The payment authorization request 216, in the form of a message, then is sent to an acquirer 208. The acquirer 208 may be a financial institution, or other merchant payment card processing company, with which the merchant has established an arrangement for processing of transactions utilizing the respective type of portable payment device 212. The acquirer 208 forwards the payment authorization request 216 to a transaction handler 206 which may be a traditional credit card company, such as Visa Inc., that processes transactions involving credit cards, debit cards, and other forms of portable payment devices. The account number contains a number of digits that identify the issuer 204 of that payment device. The transaction handler 206 parses the account number contained in the authorization request 216 to obtain the portion which identifies the issuer 204. It should be understood that the transaction handler 206 is interfaced to a large number of acquirers 208 and issuers 204 and routes numerous transaction related messages among those acquirers and issuers. The transaction handler 206 then routes the particular authorization request 216 to the associated issuer 204.

Upon receiving the payment authorization request 216, the issuer 204, or an issuer payment card processing company, examines its records maintained for the respective health savings account to determine whether the proposed transaction should be authorized or denied. Assuming that there are no problems with the respective account, the issuer 204 approves use of the health savings account to the transaction. In response to an approval, the issuer may retain certain information from the authorization request 216 for subsequent customer inquiries and/or disputes regarding HSA payment transactions to merchants. This information may be used to aid the identification of the merchant 210 to a database listing all the merchants that participated in transactions for the associated health savings account, and/or be augmented by HSA transaction records provided by the merchant, which enables the issuer to store a complete HSA transaction record. As will be described, this database enables the retrieval of information about each transaction for a given health savings account from all of the merchants that occurred during a specific period of time. Alternatively the transaction handler or acquirer, upon receiving a transaction approval reply message, can maintain the database of merchants involved with each health savings account.

Next the issuer 204 transmits a transaction authorization response or reply 218 back to the transaction handler 206 approving payment of the requested purchase transaction. That transaction authorization reply 218 contains the identification of the health savings account, and of the merchant 210 which initiated the authorization request. The information contained within the transaction authorization reply 218 enables the transaction handler 206 and the acquirer 208 to route the reply to the respective merchant 210.

Upon receiving approval of the purchase transaction, the merchant delivers the goods and services to the consumer. The transaction authorization reply 218 indicates approval of use of the health savings account portable payment device for the entire purchase, including HSA-eligible and non-HSA-eligible items. The U.S. Internal Review Service (IRS) does not require merchants or issuers to only approve eligible healthcare products when a health savings account payment card is used to make a purchase. It is the consumer's responsibility to annually report on their IRS Form 1040 the amount of eligible- and non-eligible health saving account funds uses that were made from the consumer's health savings account. It is the amount of non-health savings account eligible purchases reported on the Form 1040 for which a consumer would owe income taxes and be assessed a penalty by the IRS.

The financial portion of the transaction is essentially the same as that utilized with other types of payment devices that do not involve a health savings account. The first six digits of the account number that is read from the portable payment device 212 indicate not only the issuer 204, but also that the portable payment device is for a health savings account. As a result, when the point of sale terminal 213 receives the approval of the purchase transaction, the merchant 210 knows from parsing the account number that a health saving account is being used for payment. In response, the merchant 210 in the first transaction processing system 200 executes a record keeping routine that stores HSA transaction record data regarding the transaction in memory 214, a database of completed sales transactions. Each health savings account (HSA) transaction processed by the merchant 210 produces an HSA transaction record as depicted in Table 1. The HSA transaction record in Table 1 is exemplary and may contain additional or fewer data elements.

TABLE 1

ACCOUNT NUMBER
CONSUMER NAME
DATE AND TIME
HSA ACCOUNT NUMBER
MERCHANT NAME
STORE ADDRESS, CITY, STATE, ZIP
TOTAL TRANSACTION AMOUNT
HSA TRANSACTION SUBTOTAL
ITEM QUANTITY
ITEM COST
HSA ELIGIBLE ITEM SUBTOTAL
HSA ELIGIBILITY
ITEM DESCRIPTION
ITEM QUANTITY
ITEM COST
HSA ELIGIBLE ITEM SUBTOTAL
HSA ELIGIBILITY
ITEM DESCRIPTION

The HSA transaction record comprises an account identification section, a transaction data section, and an item information section with data about each product and service being purchased. The account identification section contains data fields that may include the account number and the consumers name read from the portable payment device. For security reasons, a truncated version of the health savings account number, containing significantly less than all the digits, may be stored so that if the data file is stolen or copied for illegal use, the records do not contain the entire account number. Alternatively, the account number may be stored using encryption. However, the portion of the account number that is stored along with other HSA transaction record data is sufficient to subsequently locate all of the transactional records for that consumer.

The transaction information section has a field that contains the date and time of the particular transaction and another field that stores the total monetary amount of the transaction. It should be understood that a particular transaction may include products that qualify for payment using a health savings account, as well as other products that do not qualify for such payment. The merchant name, store address, city, state, and ZIP code are stores. The total transaction amount stored in field is a total amount of both types of products and services. The following field contains the HSA transaction subtotal which is the sum of the HSA eligible items subtotal, taxes, and other charges minus any discounts that apply to the HSA qualified items being acquired. It is this latter amount that can be legitimately paid using funds form a health saving account.

The transaction product and services section of the HSA transaction record in Table 1 contains information about each item being purchased. Each subsection has five fields of data regarding one particular item. With respect to one item, a first subsection field designates the quantity of that item being purchased, while the second subsection field indicates the cost of one such item, and the third subsection contains the subtotal amount of the eligible items. The fourth subsection field indicates whether or not this particular item is eligible for payment via a health savings account, and a fifth field contains a description of that item by brand name and type of product, e.g. “Bayer® aspirin-250 count”. Each item being purchased, whether or not it is eligible for HSA payment may appear in the HSA transaction record.

Typically the memory 214 at the merchant 210 is located on a computer server to which a plurality of point of sale terminals 213 and an inventory database 211 in memory 214 at the same store are connected. Alternatively, where the merchant 210 part of a chain of stores, such as a pharmacy chain, the HSA transaction records stored in memory 214 may be transferred to and stored at a central computer for the entire chain. As a further alternative, a merchant may contract with a third party to provide the health savings account HSA transaction record storage and retrieval functions. In that latter case, both the merchant and such third party are collectively considered as the merchant.

At a subsequent point in time, such as once a year prior to preparing an individual income tax return, the consumer 202 may desire a report listing every transaction which utilized that person's health savings account. At that time, the consumer requests that report from the issuer 204, which as noted previously has a database for that health savings account that identifies the merchants at which such transactions occurred. Alternatively, that merchant database is maintained by the transaction handler 206. In either case, the request from the consumer 202 causes the issuer 204 or the transaction handler 206 to identify all those merchants and send a request 220 to each one requesting that information from all the HSA transaction records for the specific consumer's account be sent to the issuer. This HSA transaction record request 220 may include the health savings account number, name of the consumer associated with that account, and identification of the requesting issuer. In addition the HSA transaction record request 220 may specify a range of dates, such as a calendar year, during which the transactions must have occurred.

Upon receiving such a HSA transaction record request 220, each merchant 210 accesses its memory 214 for the health savings account transaction database and searches for transactions associated with the designated account, specifically the account number or a truncated version of that number, along with other transaction record data elements, is employed to search all the stored HSA transaction records. After finding a record for that particular health savings account, the merchant also compares the date stored in that record to determine whether the transaction occurred within the time period specified in the request. The results of the merchant 210 searching all the HSA transaction records is a compilation of the data for each HSA transaction record associated with that same account number. The merchant 210 then formulates a transaction record reply message 222 containing those relevant records and the name, address, and other information about that specific merchant. The record reply message 222 is sent to the acquirer 208, which forwards the record reply via the transaction handler 206 to the issuer 204. The issuer 204 will receive similar record reply messages from other merchants at which transactions for the specified health savings account occurred during the designated time period. The issuer 204 accumulates all the HSA transaction records for the designated account, formats the information into a report, and transmits that report to the consumer 202.

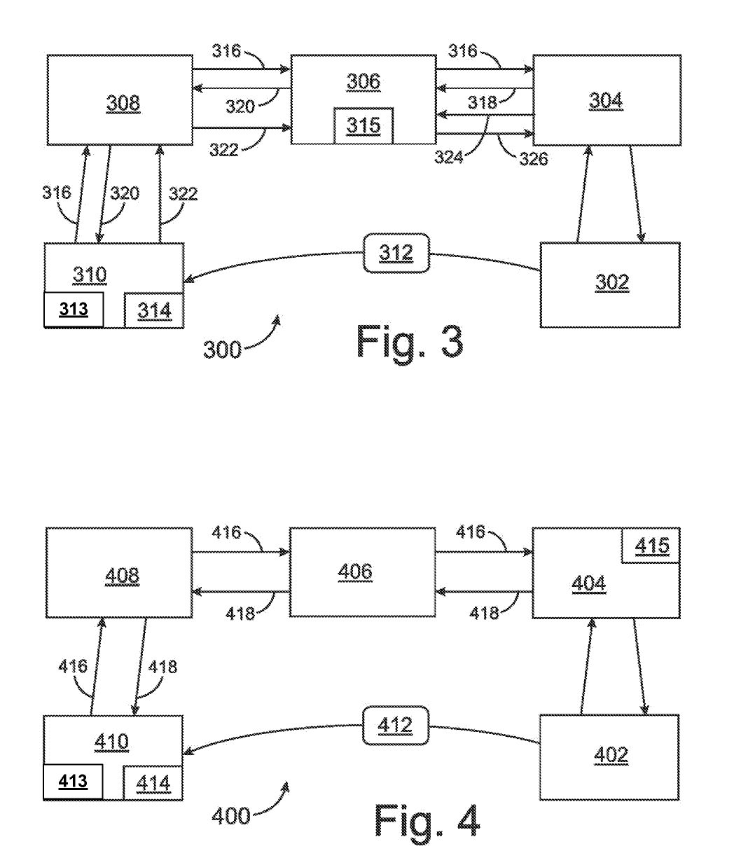

With reference to FIG. 3, instead of the merchant 310 storing information regarding each health savings account transaction, the HSA transaction records can be retained at the transaction handler 306 for all merchants which were involved in transactions for an account. Storing those records centrally for the entire second transaction processing system 300 eliminates the need for the issuer 304 to maintain a database of the merchants that handled transactions for each of the issuer's health savings accounts. In the second transaction processing system 300 when the consumer 302 presents the portable payment device 312 at a point of sale terminal 313 at a merchant 310, the merchant accesses an inventory database in memory 314 and sends an authorization request 316 via the acquirer 308 and the transaction handler 306 to the issuer 304. Now, however, upon receiving the authorization reply 318 from the issuer 304 approving the transaction, the transaction handler 306 detects from the account number in the reply that the transaction involves a health savings account. This causes the transaction handler to amend that reply by attaching a request for detailed information related to the transaction. The amended authorization reply 320 is sent via the acquirer 308 to the designated merchant 310.

The merchant 310 responds to the amended authorization reply 320 by completing the consumer's transaction and also responds by sending the transaction handler 306 a record reply message 322 containing a data file as shown in Table 2. This data file contains all the fields of the HSA transaction record described with respect to Table 1. In addition the merchant 310 now adds a merchant identification section comprising a plurality of data fields with information about the responding merchant. The first data field contains the name of the merchant and a second field contains a unique identification number assigned to that merchant by the second transaction processing system 300. The merchant's address is contained in one or more other fields. A further field is provided to store the merchant category code, which is a 4-digit code which is assigned to every merchant that accepts a particular type of portable payment device, such as a Visa® brand credit card, and identifies the products and/or services that the merchant provides. Other forms of identifiers for the type of products and services also could be used instead of the standard merchant category code. The final field of the merchant information section optionally stores the number or other identifier of the particular store and/or POS terminal within a chain of stores for the same merchant.

TABLE 2

ACCOUNT NUMBER
CONSUMER NAME
MERCHANT NAME
MERCHANT ID NUMBER
ADDRESS
MERCHANT CATEGORY CODE
STORE NUMBER
POS TERMINAL ID
DATE AND TIME
HSA ACCOUNT NUMBER
TOTAL TRANSACTION AMOUNT
HSA TRANSACTION SUBTOTAL
ITEM QUANTITY
ITEM COST
HSA ELIGIBLE ITEM SUBTOTAL
HSA ELIGIBILITY
ITEM DESCRIPTION
ITEM QUANTITY
ITEM COST
HSA ELIGIBLE ITEM SUBTOTAL
HSA ELIGIBILITY
ITEM DESCRIPTION
ITEM QUANTITY

Upon receiving the record reply message 322 from the merchant 310, the transaction handler 306 stores the transmitted data in memory 315 as an HSA transaction record. Alternatively in the second transaction processing system 300, the data in Table 2 is sent in the original authorization request 316 and is retained in a temporary memory location by the transaction handler 306. Upon receiving an authorization reply 318 approving the transaction, the transaction handler 306 stores that data as a permanent HSA transaction record in memory 315.

Thereafter when the consumer 302 requests a report of the HSA transactions that occurred during a specified period of time, the issuer 304 responds to that request by sending a data record request 324 to the transaction handler 306. The data record request 324 identifies the account number and the cardholder's name associated with the health savings account. Upon receiving that request, the transaction handler 306 searches the database in memory 315 for HSA transaction records that contain the designated account number and other identifying data elements. Each of the located HSA transaction records is assembled into single record reply 326 that is transmitted to the issuer 304, which then generates a properly formatted report for the consumer 302.

The second transaction processing system 300 has the benefit of centrally storing all of the HSA transaction records in the transaction handler 306 so that inquiries do not have to be made of numerous merchants which handled transactions using that account. Furthermore, if a merchant goes out of business or loses its data files, the more historically robust and secure data storage at the transaction handler level enables consumers to obtain a complete report of the transactions on their health savings account.

A third transaction processing system shown in FIG. 4 is similar to the previously described ones, except that the HSA transaction records are stored at the issuer 404. The purchase of goods or services is carried out in the same manner as described above in which the consumer 402 presents the portable payment device 412 to the merchant 410 that reads the device via the point of sale terminal 413 and accesses an inventory database in memory 414. The merchant responds by transmitting an authorization request 416 via the acquirer 408 and transaction handler 406 to the issuer 404. As a slight modification to the conventional transaction authorization process, the merchant 410 may recognize that this transaction involves a health savings account based on the account number of the portable payment device 412. In that case, the merchant 410 also transmits a HSA transaction record, as depicted in Table 2, along with the authorization request to the issuer. Now, when the issuer 404 approves the authorization request, the HSA transaction record is stored in a health savings account transaction database within memory 415.

In the third transaction processing system 400, when the consumer 402 desires a report about health savings account transactions, the issuer 404 already has all the necessary information for the relevant time period of the request. Thus the issuer 404 searches the database within its memory 415 for HSA transaction records associated with the designated account, generates a report of those transactions, and delivers the report to the consumer.

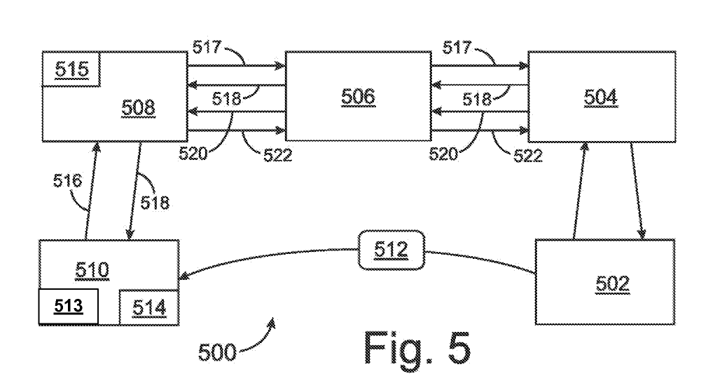

With reference to FIG. 5, a fourth transaction processing system 500 stores the HSA transaction records at the acquirer 508. The financial transaction involving the purchase of products or services utilizing a health savings account is similar to that described previously and involves the consumer 502 presenting a portable payment device 512 to the merchant 510 which reads the account number utilizing the point of sale terminal 513 and accesses an inventory database in memory 514. The financial information about the sales transaction is transmitted as an authorization request 516 to the acquirer 508. As noted previously, the acquirer 508 may be a financial institution that provides accounts to merchants for the acceptance of the portable payment device in handling financial transactions. In the course of preparing the transaction authorization request 516, the merchant recognizes from the account number that it involves a health savings account. In which case, the merchant also transmits the HSA transaction record as depicted in Table 2 with that request. Upon receiving the transaction authorization request, the acquirer 508 strips away the HSA transaction record data and stores it in a temporary storage area within memory 515. The remainder of the transaction authorization request with an appended identification of the acquirer then is sent as a truncated transaction authorization request 517 through the transaction handler 506 to the issuer 504. Alternatively, the merchant may separately transmit to the acquirer 508 the HSA transaction record as outlined in Table 2.

The issuer 504 then either approves or denies the authorization request for this transaction. The issuer 504 maintains a table for each of its health savings accounts that identifies every acquirer 508 that was involved in an approved transaction with respect to each account. The issuer 504 also sends an authorization reply 518, indicating approval or denial of the transaction, back through the transaction handler 506 to every one of those acquirers 508. Upon receiving this authorization reply 518, each acquirer matches the account number therein with the account number of the authorization request for which the HSA transaction record was stored within the temporary memory location. If the authorization reply 518 contains an approval of the transaction, the associated HSA transaction record is stored as a permanent HSA transaction record in memory 515. Otherwise, if the transaction has been declined, the HSA transaction record is deleted from the temporary memory area. The authorization reply 518 also is forwarded by acquirer 508 to the merchant 510 which then completes the sales transaction. If the HSA transaction record is submitted separately after the merchant 508 receives the authorization approval, the HSA transaction record is then transmitted to the acquirer 508 for storage in memory 515.

At a subsequent time when the consumer 502 desires a report of the health savings account activity, a request is submitted to the issuer 504. Upon receiving a consumer's request for such a report, the issuer 504 examines its table of acquirers for the designated account and sends a HSA transaction record request 520 to each of those acquirers. Each recipient acquirer 508 uses the account number and other identifying data elements in that request 520 to obtain the HSA transaction records stored within memory 515 which relate to transactions for the designated account which occurred in the time period specified in the request. The HSA transaction records retrieved from memory 515 are placed into a record reply 522, which is transmitted through the transaction handler 506 to the issuer 504. Recognizing that the fourth transaction processing system 500 has a large number of acquirers 508 connected to the transaction handler 506, meaning that a typical issuer 504 will receive a plurality of HSA transaction record replies 522 from several acquirers. When responses from all the relevant acquirers have been received, the issuer 504 generates the health savings account report and sends it to the associated consumer 502.

An Exemplary Transaction Processing System/Payment Processing Network

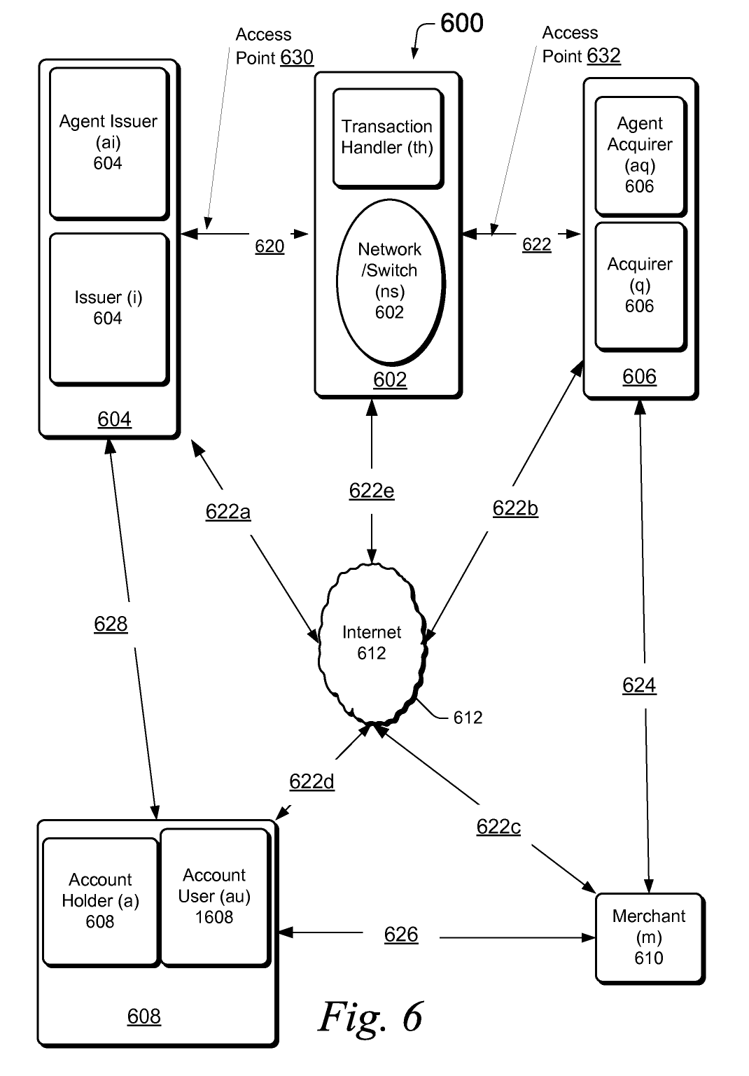

Referring to FIG. 6, a transaction processing system 600 is seen as an environment in which methods 400 and 500 in FIGS. 4-5 can be performed, and as a general example for payment processing system 300 in FIG. 3. The general environment of FIG. 6 includes that of a merchant (m) 610, such as the merchant, who can conduct a transaction for the sale of goods and/or services with an account user (au) (e.g., consumer) on an account issued to an account holder (a) 608 by an issuer (i) 604, where the processes of paying and being paid for the transaction are coordinated by at least one transaction handler (th) 602 (e.g., the transaction handler) (collectively “users”). The transaction includes participation from different entities that are each a component of the transaction processing system 600.

The transaction processing system 600 may have at least one of a plurality of transaction handlers (th) 602 that includes transaction handler (l) 602 through transaction handler (TH) 602, where TH can be up to and greater than an eight digit integer.

The transaction processing system 600 has a plurality of merchants (m) 610 that includes merchant (l) 610 through merchant (M) 610, where M can be up to and greater than an eight digit integer. Merchant (m) 610 may be a person or entity that sells goods and/or services. Merchant (m) 610 may also be, for instance, a healthcare service provider who can administer a controlled substance (e.g.; a drug) to a patient. In a business-to-business setting, the account holder (a) 608 may be a second merchant (m) 610 making a purchase from another merchant (m) 610.

Transaction processing system 600 includes account user (l) 608 through account user (AU) 608, where AU can be as large as a ten digit integer or larger. Each account user (au) conducts a transaction with merchant (m) 610 for goods and/or services using the account that has been issued by an issuer (i) 604 to a corresponding account holder (a) 608. Data from the transaction on the account is collected by the merchant (m) 610 and forwarded to a corresponding acquirer (a) 606. Acquirer (a) 606 forwards the data to transaction handler (th) 602 who facilitates payment for the transaction from the account issued by the issuer (i) 604 to account holder (a) 608.

Transaction processing system 600 has a plurality of acquirers (q) 606. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger. Each acquirer (q) 606 may be assisted in processing one or more transactions by a corresponding agent acquirer (aq) 606, where ‘q’ can be an integer from 1 to Q, where aq can be an integer from 1 to AQ, and where Q and AQ can be as large as a eight digit integer or larger.

The transaction handler (th) 602 may process a plurality of transactions within the transaction processing system 600. The transaction handler (th) 602 can include one or a plurality or networks and switches (ns) 602. Each network/switch (ns) 602 can be a mainframe computer in a geographic location different than each other network/switch (ns) 602, where ‘ns’ is an integer from one to NS, and where NS can be as large as a four digit integer or larger.

Dedicated communication systems 620, 622 (e.g., private communication network(s)) facilitate communication between the transaction handler (th) 602 and each issuer (i) 604 and each acquirer (a) 606. A Network 612, via e-mail, the World Wide Web, cellular telephony, satellite, and/or other optionally public and private communications systems, can facilitate communications 622a-622e among and between each issuer (i) 604, each acquirer (a) 606, each merchant (m) 610, each account holder (a) 608, and the transaction handler (th) 602. Alternatively and optionally, one or more dedicated communication systems 624, 626, and 628 can facilitate respective communications between each acquirer (a) 606 and each merchant (m) 610, each merchant (m) and each account holder (a) 608, and each account holder (a) 608 and each issuer (i) 604, respectively.

The Network 612 may represent any of a variety of suitable means for exchanging data, such as: an Internet, an intranet, an extranet, a wide area network (WAN), a local area network (LAN), a virtual private network, a satellite communications network, an Automatic Teller Machine (ATM) network, an interactive cellular telephone or handheld device or television network, or any combination of the forgoing. Network 612 may contain either or both wired and wireless connections for the transmission of signals including electrical, magnetic, and a combination thereof. Examples of such connections are known in the art and include: radio frequency connections, optical connections, etc. To illustrate, the connection for the transmission of signals may be a telephone link, a Digital Subscriber Line, or cable link. Moreover, network 612 may utilize any of a variety of communication protocols, such as Transmission Control Protocol/Internet Protocol (TCP/IP), for example. There may be multiple nodes within the network 612, each of which may conduct some level of processing on the data transmitted within the transaction processing system 600.

Users of the transaction processing system 600 may interact with one another or receive data about one another within the transaction processing system 600 using any of a variety of communication devices. The communication device may have a processing unit operatively connected to a display and memory such as Random Access Memory (“RAM”) and/or Read-Only Memory (“ROM”). The communication device may be combination of hardware and software that enables an input device such as a keyboard, a mouse, a stylus and touch screen, or the like.

For example, use of the transaction processing system 600 by the account holder (a) 608 may include the use of a portable consumer device (PCD). The PCD may be one of the communication devices, or may be used in conjunction with, or as part of, the communication device. The PCD may be in a form factor that can be: a card (e.g., bank card, payment card, financial card, credit card, charge card, debit card, gift card, transit pass, smart card, access card, a payroll card, security card, healthcare card, university card, or telephone card), a tag, a wristwatch, wrist band, a key ring, a fob (e.g., SPEEDPASS® commercially available from ExxonMobil Corporation), an integrated circuit chip card (e.g., Visa smart cards or Visa payWave card commercially available from Visa Inc., and MasterCard smart cards or MasterCard PayPass card commercially available from MasterCard International), a machine readable medium containing account information, a pager, a cellular telephone, a personal digital assistant, a digital audio player, a computer (e.g., laptop computer), a digital game system, a set-top box, a portable workstation, a minicomputer, or a combination thereof. The PCD may have near field or far field communication capabilities (e.g., Internet or satellite communication or communication to cell sites of a cellular network) for telephony or data transfer such as communication with a global positioning system (GPS). The PCD may support a number of services such as Short Message Service (Text SMS) for text messaging and Multimedia Messaging Service (MMS) for transfer of photographs and videos, electronic mail (e-mail) access.

The PCD may include a computer readable medium. The computer readable medium, such as a magnetic stripe or a memory of a chip or a chipset, may include a volatile, a non-volatile, a read only, or a programmable memory that stores data, such as an account identifier, a consumer identifier, and/or an expiration date. The computer readable medium may including executable instructions that, when executed by a computer, the computer will perform a method or application. For example, the computer readable memory may include information such as the account number or an account holder (a) 608's name.

Examples of the PCD with memory and executable instructions include: a smart card, a personal digital assistant, a digital audio player, a cellular telephone, a personal computer, a digital game system, or a combination thereof. To illustrate, the PCD may be a financial card that can be used by a consumer to conduct a contactless transaction with a merchant, where the financial card includes a microprocessor, a programmable memory, and a transponder (e.g., transmitter or receiver). The financial card can have near field communication capabilities, such as by one or more radio frequency communications such as are used in a “Bluetooth” communication wireless protocol for exchanging data over short distances from fixed and mobile devices, thereby creating personal area networks.

Merchant (m) 610 may utilize at least one Point of Interaction (POI) terminal (e.g., Point of Service or browser enabled consumer cellular telephone); that can communicate with the account user (au) 608, the acquirer (a) 606, the transaction handler (th) 602, or the issuer (i) 604. A POI can be a physical or virtual communication vehicle that provides the opportunity, through any channel to engage with the consumer for the purposes of providing content, messaging or other communication, related directly or indirectly to the facilitation or execution of a transaction between the merchant (m) 610 and the consumer. Examples of the POI include: a physical or virtual Point of Service (POS) terminal, the PCD of the consumer, a portable digital assistant, a cellular telephone, paper mail, e-mail, an Internet website rendered via a browser executing on computing device, or a combination of the forgoing. Thus, the POI terminal is in operative communication with the transaction processing system 600.

The PCD may interface with the POI using a mechanism including any suitable electrical, magnetic, or optical interfacing system such as a contactless system using radio frequency, a magnetic field recognition system, or a contact system such as a magnetic stripe reader. To illustrate, the POI may have a magnetic stripe reader that makes contact with the magnetic stripe of a healthcare card (e.g., Health Savings Account card) of the consumer. As such, data encoded in the magnetic stripe on the healthcare card of consumer read and passed to the POI at merchant (m) 610. These data can include an account identifier of a healthcare account. In another example, the POI may be the PCD of the consumer, such as the cellular telephone of the consumer, where the merchant (m) 610, or an agent thereof, receives the account identifier of the consumer via a webpage of an interactive website rendered by a browser executing on a World Wide Web (Web) enabled PCD.

Typically, a transaction begins with account user (au) 608 presenting the portable consumer device to the merchant (m) 610 to initiate an exchange for resources (e.g., a good or service). The portable consumer device may be associated with an account (e.g., a credit account) of account holder (a) 608 that was issued to the account holder (a) 608 by issuer (i) 604.

Merchant (m) 610 may use the POI terminal to obtain account information, such as a number of the account of the account holder (a) 608, from the portable consumer device. The portable consumer device may interface with the POI terminal using a mechanism including any suitable electrical, magnetic, or optical interfacing system such as a contactless system using radio frequency or magnetic field recognition system or contact system such as a magnetic stripe reader. The POI terminal sends a transaction authorization request to the issuer (i) 604 of the account associated with the PCD. Alternatively, or in combination, the PCD may communicate with issuer (i) 604, transaction handler (th) 602, or acquirer (a) 606.

Issuer (i) 604 may authorize the transaction and forward same to the transaction handler (th) 602. Authorization includes issuer (i) 604, or transaction handler (th) 602 on behalf of issuer (i) 604, authorizing the transaction in connection with issuer (i) 604's instructions such as through the use of business rules. The business rules could include instructions or guidelines from the transaction handler (th) 602, the account holder (a) 608, the merchant (m) 610, the acquirer (a) 606, the issuer (i) 604, a related financial institution, or combinations thereof. The transaction handler (th) 602 may, but need not, maintain a log or history of authorized transactions. Once approved, the merchant (m) 610 may record the authorization, allowing the account user (au) 608 to receive the good or service from merchant (m) or an agent thereof.

The merchant (m) 610 may, at discrete periods, such as the end of the day, submit a list of authorized transactions to the acquirer (a) 606 or other transaction related data for processing through the transaction processing system 600. The transaction handler (th) 602 may optionally compare the submitted authorized transaction list with its own log of authorized transactions. The transaction handler (th) 602 may clear the approved authorizations among all acquirers and issuers, determining the net settlement amount to debit and/or credit the corresponding the acquirer (a) 606 to the corresponding issuer (i) 604 involved in each transaction. Once the acquirer (a) 606 receives the payment of the authorized transaction from the issuer (i) 604, the acquirer (a) 606 can forward the payment to the merchant (m) 610 less any transaction costs, such as fees for the processing of the transaction, based upon the contractual arrangements in place between the acquirer and merchant.

There may be intermittent steps in the foregoing process, some of which may occur simultaneously. For example, the acquirer (a) 606 can initiate the clearing and settling process, which can result in payment to the acquirer (a) 606 for the amount of the transaction. The acquirer (a) 606 may request from the transaction handler (th) 602 that the transaction be cleared and settled. Clearing includes the exchange of financial information between the issuer (i) 604 and the acquirer (a) 606 and settlement includes the exchange of funds. The transaction handler (th) 602 can provide services in connection with settlement of the transaction. The settlement of a transaction includes depositing an amount of the transaction settlement from a settlement house, such as a settlement bank, which transaction handler (th) 602 typically chooses, in the account maintained by the acquirer (a) 606. The issuer (i) 604 deposits its net settlement amount due into the settlement house. Thus, a typical transaction involves various entities to request, authorize, and fulfill processing the transaction.

The transaction processing system 600 will preferably have network components suitable for scaling the number and data payload size of transactions that can be authorized, cleared and settled in both real time and batch processing. These include hardware, software, data elements, and storage network devices for the same. Examples of transaction processing system 600 include those operated, at least in part, by: American Express Travel Related Services Company, Inc; MasterCard International, Inc.; Discover Financial Services, Inc.; First Data Corporation; Diners Club International, LTD; Visa Inc.; and agents of the foregoing.

Each of the network/switch (ns) 602 can include one or more data centers for processing transactions, where each transaction can include up to 100 kilobytes of data or more. The data corresponding to the transaction can include information about the types and quantities of goods and services in the transaction, information about the account holder (a) 608, the account user (au) 608, the merchant (m) 610, tax and incentive treatment(s) of the goods and services, coupons, rebates, rewards, loyalty, discounts, returns, exchanges, cash-back transactions, etc.

By way of example, network/switch (ns) 602 can include one or more mainframe computers (e.g., one or more IBM mainframe computers) for one or more server farms (e.g., one or more Sun UNIX Super servers), where the mainframe computers and server farms can be in diverse geographic locations.

Each issuer (i) 604 (or agent issuer (ai) 604 thereof) and each acquirer (a) 606 (or agent acquirer (aq) 606 thereof) can use or more router/switch (e.g., Cisco™ routers/switches) to communicate with each network/switch (ns) 602 via dedicated communication systems.

Transaction handler (th) 602 can store information about transactions processed through transaction processing system 600 in data warehouses such as may be incorporated as part of the plurality of networks/switches 602. This information can be data mined. The data mining transaction research and modeling can be used for advertising, account holder and merchant loyalty incentives and rewards, fraud detection and prediction, and to develop tools to demonstrate savings and efficiencies made possible by use of the transaction processing system 600 over paying and being paid by cash, or other traditional payment mechanisms.

The VisaNet® system is an example component of the transaction handler (th) 602 in the transaction processing system 600. Presently, the VisaNet® system is operated in part by Visa Inc. As of 2006, the VisaNet® system Inc. was processing around 300 million transactions daily, on over 1 billion accounts used in over 170 countries. Financial instructions numbering over 16,000 connected through the VisaNet® system to around 30 million merchants (m) 610. In 2007, around 81 billion transactions for about 4 trillion U.S. dollars were cleared and settled through the VisaNet® system, some of which involved a communication length of around 24,000 miles in around two (2) seconds and during which a plurality of stops are made for processing data in the transaction.

FIG. 6 illustrates a telecommunications network that may make use of any suitable telecommunications network and may involve different hardware, different software and/or different protocols then those discussed below. FIG. 6 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account, and the subsequent process of calculating and determining the net financial position of each acquirer and issuer for all transactions that are cleared. Settlement is the actual exchange of funds.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization occurs online, although can be completed via telephone. For dual message transactions, clearing and settlement is most frequently completed through the batch submission of transactions prior to clearing processing. For single message transactions, a method is used where all approved single message authorizations are batched together for clearing processing. Once clearing processing is completed, the net settlement positions of each acquirer and issuer are determined, and instructions to effect funds movement for settlement are sent to the settlement bank.

FIG. 6 includes access points 630, 632. Entities such as drawee banks and third party authorizing agents may also connect to the telecommunications network seen in FIG. 6. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (Transaction Handler (th) 602) to remote entities use dedicated high-bandwidth telephone circuits or satellite connections based on the IBM SNA-LU0 communication protocol. Messages are sent over these lines using any suitable implementation of the ISO 8583 standard.

Access points 630, 632 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) 606 and its access point, and between the access point and issuer (i) 604 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

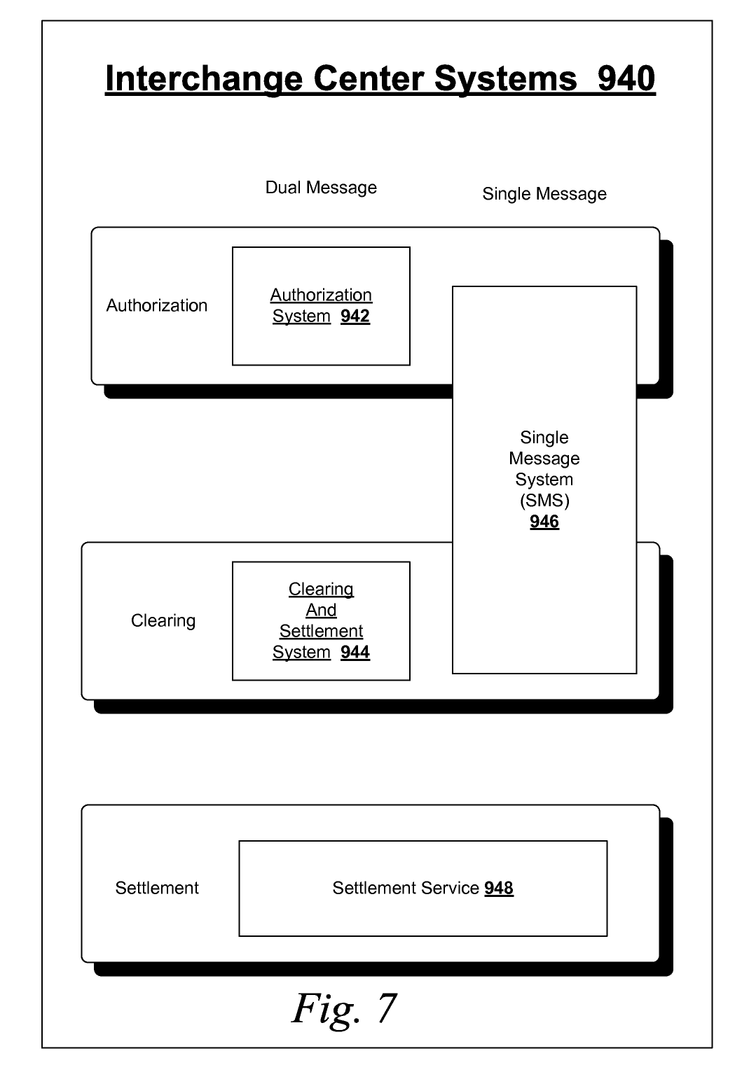

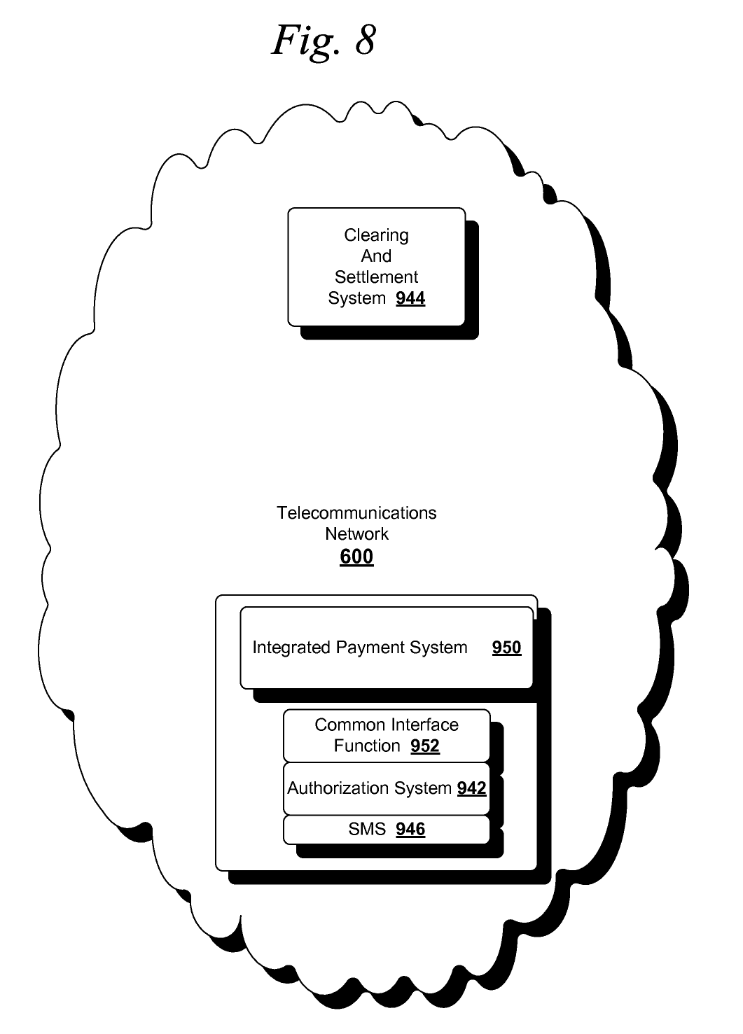

FIG. 7 illustrates systems 940 housed within an interchange center to provide on-line and off-line transaction processing. For dual message transaction, authorization system 942 provides authorization. System 942 supports on-line and off-line functions, and its file includes internal systems tables, a customer database and a merchant central file. The on-line functions of system 942 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 942 to system 946 makes it possible for members using system 942 to communicate with members using system 946 and access the Single Message Ssystem gateways to outside networks.

Clearing and settlement system 944 clears and settles previously authorized dual message transactions. Operating six days a week on a global basis, system 944 collects financial and non-financial information and distributes reports between members It also calculates fees, charges and settlement totals and produces reports to help with reconciliation. A bridge forms an interchange between system 944 processing centers and system 846 processing centers.

Single message system 946 processes full financial transactions. System 946 can also process dual message authorization and clearing transactions, and communicates with system 942 using a bridge and accesses outside networks as required. System 946 processes Visa, Plus Interlink and other card transactions. The single message system files comprise internal system tables that control system access and processing, and the cardholder database, which contains files of cardholder data used for PIN verification and stand-in processing authorization. System 946 on-line functions perform real-time cardholder transaction processing and exception processing for authorization as well as full financial transactions. System 946 also accumulates reconciliation and settlement totals. System 946 off-line functions process settlement and funds transfer requests and provide settlement and activities reporting. Settlement service 948 consolidates the settlement functions of system 944 and 946, including Interlink, into a single service for all products and services. Clearing continues to be performed separately by system 944 and system 946.

FIG. 8 illustrates another view of components of FIG. 6 as a telecommunications network 100. Integrated payment system 950 is the primary system for processing all on-line authorization and financial request transactions. System 950 reports both dual message and single message processing. In both cases, settlement occurs separately. The three main software components are the common interface function 952, authorization system 942 and single message system 946.

Common interface function 952 determines the processing required for each message received at an interchange center. It chooses the appropriate routing, based on the source of the message (system 942, 944 or 946), the type of processing request and the processing network. This component performs initial message editing, and, when necessary, parses the message and ensures that the content complies with basic message construction rules. Common interface function 952 routes messages to their system 942 or system 946 destinations.

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed implementations is provided to enable any person of ordinary skill in the art to make or use the disclosure. Various modifications to these implementations will be readily apparent to those of ordinary skill in the art, and the generic principles defined herein may be applied to other implementations without departing from the spirit or scope of the disclosure. Thus, the disclosure is not intended to be limited to the implementations shown herein but is to be accorded the widest scope consistent with the principles and novel features disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising a plurality of steps each being performed by hardware executing software, wherein the steps include:
sending a payment authorization request requesting use of an account to conduct for a sales transaction for a purchase of one or more items by a consumer;
determining whether each said item requested for the purchase by the consumer in the sales transaction is qualified under the account; and
storing an account transaction record which contains information of the determination of each said item for being qualified under the account for the sales transaction, wherein for each of a plurality of said sales transactions:
the sales transaction is processed by a transaction handler in a transaction processing system;
the sales transaction is characterized by a consumer making a purchase of one or more items from a merchant; and
payment is made upon the account that was issued to the consumer by an issuer.

2. The method as recited in claim 1, wherein each of the steps of the sending, the determining, and the storing are performed at the merchant.

3. The method as recited in claim 1, wherein the steps further comprise transmitting data for the account transaction record to the transaction handler for performing the storing of the account transaction record.

4. The method as recited in claim 3, wherein the transaction handler performs the step of the determining.

5. The method as recited in claim 1, wherein the steps further comprise transmitting data for the account transaction record to the issuer for performing the step of the storing of the account transaction record.

6. The method as recited in claim 1, wherein:
the transaction processing system further includes an acquirer that interfaces the merchant to the transaction handler; and
the steps further comprise transmitting data for the account transaction record to the acquirer for the performing of the step of the storing of the account transaction record.

7. The method as recited in claim 1, wherein the account transaction record identifies a date of the one said sales transaction, the account, each said item that is qualified for purchase under the account, and data enabling a determination of a total monetary amount of the transaction related to each said item that is determined to be a qualified item.

8. The method as recited in claim 7, wherein the account transaction record further identifies, for said qualified item, a quantity and a unit cost.

9. The method as recited in claim 1, wherein the steps further comprise:
reading the stored account transaction record; and
generating a report from data contained in the stored account transaction record.

10. The method as recited in claim 1, wherein:
the steps further comprise storing identification of a plurality of said items that are each eligible for purchase using the account according to predetermined criteria; and
the determining of whether each said item requested for purchase by the consumer in the one said sales transaction is qualified under the account employs the identification of the plurality of said items.

11. A computer readable medium comprising the software which, when executed by the hardware, the hardware performs the steps of claim 1.

12. In a transaction processing system in which a transaction handler processes a plurality of sales transactions, each characterized by a consumer making a purchase from a merchant wherein payment is made upon an account issued to the consumer by an issuer, a method of handling a given sales transaction involving a purchase of one or more items and payment via an account, said method comprising a plurality of steps each being performed by hardware executing software, wherein the steps include:
entering an identity for each of one or more said items which the consumer desires to purchase;
obtaining, from the consumer, identification of the account;
determining, for each said item desired to be purchased, whether the item is a qualified product under the account by comparing the entered identity for the item against stored identifications of qualified products eligible for purchase using the account; and
storing an account transaction record which identifies a date of the given sales transaction, the account, each said item that is a qualified product as determined by the determining step, and data enabling a calculation of a total monetary amount of the given sales transaction related to each said item that is a qualified product.

13. The method as recited in claim 12, wherein the steps further comprise:
sending, from the merchant, an authorization request requesting use of the account for payment;
determining at the issuer that the authorization request is authorized; and
sending, from the issuer, an authorization approval reply to said merchant.

14. The method as recited in claim 12, wherein:
the steps further comprise storing the identification of qualified products eligible for purchase using the account; and
both the steps of the determining and the storing of the account transaction record are performed at the merchant.

15. The method as recited in claim 12, where the steps further comprise transmitting a message that one said item is not one said qualified product under the account as determined by the determining step.

16. The method as recited in claim 12, where the steps further comprise transmitting data for the account transaction record to the transaction handler for the performing of the storing of the account transaction record.

17. The method as recited in claim 16, wherein the transaction handler performs the determining step.

18. The method as recited in claim 12, wherein:
the steps further comprise transmitting data for the account transaction record to the issuer; and
the issuer performs the step of the storing of the account transaction record.

19. The method as recited in claim 12, wherein:
the transaction processing system further includes an acquirer that interfaces the merchant to the transaction handler;
the steps further comprise transmitting data for the account transaction record to the acquirer; and
the acquirer performs the step of the storing of the account transaction record.

20. The method as recited in claim 12, wherein the account transaction record contains information sufficient to identify for each said item in the given sales transaction that is a qualified product as determined by the determining step:
a quantity of the item; and
a unit cost of the item.

21. The method as recited in claim 12, wherein the steps further comprise:
reading the stored account transaction record; and
generating a report from information contained in the stored account transaction record.

22. A computer readable medium comprising the software which, when executed by the hardware, the hardware performs the steps of claim 12.

23. An apparatus comprising:
means for entering an identity of at least one item which a consumer desires to purchase in a given sales transaction;
means for obtaining, from the consumer, identification of an account;
means for comparing the entered identity for each said item against stored identifications of qualified products eligible for purchase using the account to determine whether the item is a qualified product under the account; and
means for storing an account transaction record which identifies:
a date of the given sales transaction;
the account;
each said item that is a qualified product under the account as determined by the means for comparing; and
information enabling a calculation of a total monetary amount of the given sales transaction related to each of the items that is a qualified product under the account, wherein:
the given sales transaction is processed in a transaction processing system in which a transaction handler processes a plurality of said sales transactions each characterized by:
by one said consumer making a purchase from a merchant; and
payment being made upon one said account that was issued to the one said consumer by an issuer.

24. The apparatus as defined in claim 23, further comprising means for processing the given sales transaction to obtain payment for each of the items that is a qualified product under the account, wherein the means for processing the given sales transaction includes:
the transaction processing system in which the transaction handler processes the plurality of said sales transactions each characterized by:
one said consumer making a purchase from one said merchant wherein payment is made upon one said account that was issued to the one said consumer by an issuer;
the one said merchant submitting the sales transaction to a corresponding acquirer for processing by the transaction handler who requests the issuer of the corresponding said account to obtain payment for the sales transaction from the corresponding said account and for which the issuer forwards the payment to the transaction handler who forwards the payment to the acquirer to pay the one said merchant for the sales transaction.
